(19) United States
(12) Patent Application Publication
(10) Pub. No.: US 2008/0048152 A1
(43) Pub. Date: Feb. 28, 2008

(54) Process for producing nano-scaled platelets and nanocompsites

(76) Inventors: Bor Z. Jang, Centerville, OH (US); Aruna Zhamu, Centerville, OH (US); Jiusheng Guo, Centerville, OH (US)

Correspondence Address: Bor Z. Jang, 9436 Parkside Drive, Centerville, OH, 45458, US

(21) Appl. No.: 11/509,424

(22) Filed: Aug. 25, 2006

(51) Int. Cl. C01B 31/04

(52) U.S. Cl. 252/378 R; 423/448

(57) ABSTRACT

Disclosed is a process for exfoliating a layered material to produce nano-scaled platelets having a thickness smaller than 100 nm, typically smaller than 10 nm, and often between 0.34 nm and 1.02 nm. The process comprises: (a) subjecting a layered material to a gaseous environment at a first temperature and first pressure sufficient to cause gas species to penetrate between layers of the layered material, forming a gas-intercalated layered material; and (b) subjecting the gas-intercalated layered material to a second pressure, or a second pressure and a second temperature, allowing gas species to partially or completely escape from the layered material and thereby exfoliating the layered material to produce partially delaminated or totally separated platelets. The gaseous environment preferably contains only environmentally benign gases that are reactive (e.g., oxygen) or non-reactive (e.g., noble gases) with the layered material. The process can also include dispersing the platelets in a matrix material to form a nanocomposite.

This invention is based on the research result of a DoE SBIR project. The US government has certain rights on this invention.

### FIELD OF THE INVENTION

The present invention relates generally to a process for producing nano-scaled plate-like or sheet-like structures and their nanocomposites and, particularly, to nano-scaled graphene platelets (NGPs) and NGP nanocomposites.

### BACKGROUND

Carbon is known to have four unique crystalline structures, including diamond, graphite, fullerene and carbon nano-tubes. The carbon nano-tube (CNT) refers to a tubular structure grown with a single wall or multi-wall, which can be conceptually obtained by rolling up a graphene sheet or several graphene sheets to form a concentric hollow structure. A graphene sheet is composed of carbon atoms occupying a two-dimensional hexagonal lattice. Carbon nano-tubes have a diameter on the order of a few nanometers to a few hundred nanometers. Carbon nano-tubes can function as either a conductor or a semiconductor, depending on the rolled shape and the diameter of the tubes. Its longitudinal, hollow structure imparts unique mechanical, electrical and chemical properties to the material. Carbon nano-tubes are believed to have great potential for use in field emission devices, hydrogen fuel storage, rechargeable battery electrodes, and composite reinforcements.

However, CNTs are extremely expensive due to the low yield and low production and purification rates commonly associated with all of the current CNT preparation processes. The high material costs have significantly hindered the widespread application of CNTs. Rather than trying to discover much lower-cost processes for nano-tubes, we have worked diligently to develop alternative nano-scaled carbon materials that exhibit comparable properties, but can be produced in larger quantities and at much lower costs. This development work has led to the discovery of processes for producing individual nano-scaled graphite planes (individual graphene sheets) and stacks of multiple nano-scaled graphene sheets, which are collectively called “nano-scaled graphene plates (NGPs).” NGPs could provide unique opportunities for solid state scientists to study the structures and properties of nano carbon materials. The structures of these materials may be best visualized by making a longitudinal scission on the single-wall or multi-wall of a nano-tube along its tube axis direction and then flattening up the resulting sheet or plate. Studies on the structure-property relationship in isolated NGPs could provide insight into the properties of a fullerene structure or nano-tube. Furthermore, these nano materials could potentially become cost-effective substitutes for carbon nano-tubes or other types of nano-rods for various scientific and engineering applications.

For instance, the following researchers have pointed out the great potential of using NGPs as a new microelectronic device substrate material or a functional material:
1. K. S. Novoselov, et al., “Electric field effect in atomically thin carbon films,” Science 306 (2004) 666-669.
2. K. S. Novoselov, K. S. et al., “Two-dimensional gas of massless Dirac fermions in graphene,” Nature, 438 (2005) 197-200.
3. Y. Zhang, Y-W, Tan, H. L. Stormer and P. Kim, “Experimental observation of the quantum Hall effect and Berry's phase in graphene,” Nature, 438 (2005) 201-204.
4. Y. Zhang, J. P. Small, M. E. Amori, and P. Kim, “Electric field modulation of galvanomagnetic properties of mesoscopic graphite,” Phys. Rev. Lett., 94 (2005) 176803.
5. C. Berger, et al., “Ultrathin epitaxial graphite: two-dimensional electron gas properties and a route toward graphene-based nanoelectronics,” J. Phys. Chem. B 108 (2004) 19912-19916.

Direct synthesis of the NGP material had not been possible, although the material had been conceptually conceived and theoretically predicted to be capable of exhibiting many novel and useful properties. Jang and Huang have provided an indirect synthesis approach for preparing NGPs and related materials [B. Z. Jang and W. C. Huang, “Nano-scaled Graphene Plates,” U.S. Pat. No. 7,071,258 (Jul. 4, 2006)]. Another process developed by B. Z. Jang, et al. [“Process for Producing Nano-scaled Graphene Plates,” U.S. patent pending, Ser. No. 10/858,814 (Jun. 3, 2004)] involves (1) providing a graphite powder containing fine graphite particles (particulates, short fiber segments, carbon whisker, graphitic nano-fibers, or combinations thereof) preferably with at least one dimension smaller than 200 μm (most preferably smaller than 1 μm); (2) exfoliating the graphite crystallites in these particles in such a manner that at least two graphene planes are either partially or fully separated from each other, and (3) mechanical attrition (e.g., ball milling) of the exfoliated particles to become nano-scaled to obtain NGPs. The starting powder type and size, exfoliation conditions (e.g., intercalation chemical type and concentration, temperature cycles, and the mechanical attrition conditions (e.g., ball milling time and intensity) can be varied to generate, by design, various NGP materials with a wide range of graphene plate thickness, width and length values. Ball milling is known to be an effective process for mass-producing ultra-fine powder particles. The processing ease and the wide property ranges that can be achieved with NGP materials make them promising candidates for many important industrial applications. The electronic, thermal and mechanical properties of NGP materials are expected to be comparable to those of carbon nano-tubes; but NGP will be available at much lower costs and in larger quantities.

In this and other methods for making separated graphene or other non-carbon inorganic platelets, the process begins with intercalating lamellar flake particles with an expandable intercalation compound (intercalant), followed by expanding the intercalant to exfoliate the flake particles. Conventional intercalation methods and recent attempts to produce exfoliated products or separated platelets are given in the following representative references:
6. J. W. Kraus, et al., “Preparation of Vermiculite Paper,” U.S. Pat. No. 3,434,917 (Mar. 25, 1969).
7. L. C. Olsen, et al., “Process for Expanding Pyrolytic Graphite,” U.S. Pat. No. 3,885,007 (May 20, 1975).
8. A. Hirschvogel, et al., “Method for the Production of Graphite-Hydrogensulfate,” U.S. Pat. No. 4,091,083 (May 23, 1978).
9. T. Kondo, et al., “Process for Producing Flexible Graphite Product,” U.S. Pat. No. 4,244,934 (Jan. 13, 1981).
10. R. A. Greinke, et al., “Intercalation of Graphite,” U.S. Pat. No. 4,895,713 (Jan. 23, 1990).
11. F. Kang, “Method of Manufacturing Flexible Graphite,” U.S. Pat. No. 5,503,717 (Apr. 2, 1996).
12. F. Kang, “Formic Acid-Graphite Intercalation Compound,” U.S. Pat. No. 5,698,088 (Dec. 16, 1997).
13. P. L. Zaleski, et al. “Method for Expanding Lamellar Forms of Graphite and Resultant Product,” U.S. Pat. No. 6,287,694 (Sep. 11, 2001).
14. J. J. Mack, et al., “Chemical Manufacture of Nanostructured Materials,” U.S. Pat. No. 6,872,330 (Mar. 29, 2005).
15. Morrison, et al., “Forms of Transition Metal Dichalcogenides,” U.S. Pat. No. 4,822,590 (Apr. 18, 1989).

One common feature of these methods is the utilization of liquid or solution-based chemicals to intercalate graphite or other inorganic flake particles. These chemicals often comprise strong acids (e.g., sulfuric or nitric acids), solvents, or other undesirable species that can reside in the material. For instance, Mack, et al. [Ref. 14] intercalated laminar materials with alkali metals (e.g. Li, Na, K, Rb, Cs), alkaline earth metals (e.g. Mg, Ca, Sr, Ba), Eu, Yb, or Ti. Intercalation of these elements was accomplished by five different routes: (1) intercalated electrochemically using a non-aqueous solvent; (2) using an alkali plus naphthalene or benzophenone along with a non-aqueous solvent (usually an ether such as tetrahydrofuran); (3) using amalgams (metal+mercury); (4) dissolving any of the afore-mentioned metals in a liquid ammonia solution to create solvated ions; and (5) using n-butyl lithium in a hydrocarbon solvent (e.g., hexane).

In addition to the utilization of undesirable chemicals, in most of these methods of graphite intercalation and exfoliation, a tedious washing step is required, which produces contaminated waste water that requires costly disposal steps. Conventional exfoliation methods normally involve a very high furnace temperature (typically between 500° C. and 2,500° C.) since the process depends on vaporization or decomposition of a liquid or solid intercalant. Intercalation with an alkali or alkaline earth metal normally entails immersing the layered material in a metal compound solution (rather than pure metal), allowing the metal ions to penetrate into the inter-layer galleries (interstitial spaces). Typically, metal ion content is relatively low compared to other elements in such a compound solution (e.g., in a solution of 20% by weight lithium chloride in water, lithium content is only 3.27% by weight). Hence, only a small amount of ions from a relatively dilute solution penetrates and stays sporadically in these spaces. The resulting exfoliated product often exhibits platelets of widely varying thicknesses and many incompletely delaminated layers.

It is therefore an object of the present invention to provide an environmentally benign process for exfoliating a laminar (layered) compound or element, such as graphite, graphite oxide, and transition metal dichalcogenides, without using undesirable intercalating chemicals.

It is another object of the present invention to provide an environmentally benign process for exfoliating a laminar compound or element to produce nano-scaled platelets (platelets with a thickness smaller than 100 nm, mostly smaller than 10 nm, typically smaller than 1 nm).

It is still another object of the present invention to provide a process for producing nano-scaled platelets that can be readily dispersed in a liquid to form a nanocomposite structure.

Another object of the present invention is to provide a relatively low-temperature process for producing nano-scaled platelets with relatively uniform thicknesses.

### SUMMARY OF THE INVENTION

In summary, the present invention provides a process for exfoliating a layered (laminar) material to produce nano-scaled platelets having a thickness smaller than 100 nm. The process comprises: (a) subjecting a layered material to a gaseous environment at a first temperature and first pressure sufficient to cause gas species to penetrate (into the interstitial space, also referred to as the interlayer gallery) between layers of the layered material, forming a gas-intercalated layered material; and (b) subjecting the gas-intercalated layered material to a second pressure, or a second pressure and a second temperature, allowing gas species to pressurize and expand the interstitial space between layers (and to partially or completely escape from the layered material), thereby exfoliating the layered material to produce the platelets.

In a preferred embodiment, the step (a) of subjecting a layered material to a gaseous environment comprises placing the material in a sealed vessel containing a pressurized gas (typically at a pressure greater than 1 atm) at a first temperature (typically room temperature or slightly higher) and step (b) comprises removing the gas-intercalated material from the vessel, preferably into a furnace or oven at a pre-set temperature (typically much higher than room temperature; e.g., 100° C. to 500° C.). The pressurized gas, supplied from a gas cylinder, can penetrate into the interstitial space between layers and stay therein under a pressure. The amount (solubility) of gas species that can reside in the interstitial space at a given temperature increases with the increasing pressure. After a duration of gas intercalation time, the excess pressurized gas in the vessel is released (so the second pressure is lower than the first pressure) and the gas-intercalated layered material is removed from the vessel and quickly placed in a furnace (with the second temperature higher than the first temperature), allowing the gas species to expand and exfoliate the layered material.

The starting layered material preferably comprises small particles with a dimension smaller than 10 μm and more preferably smaller than 1 μm. The gas preferably is selected from hydrogen, helium, neon, argon, nitrogen, oxygen, fluorine, carbon dioxide, or a combination thereof. The process may include an additional step of applying air milling, ball milling, mechanical attrition, and/or sonification to further separate the platelets and/or reduce a size of the platelets. The resulting platelets typically have a thickness smaller than 10 nm and many have a thickness smaller than 1 nm. For graphite flakes, the resulting graphene platelets typically contain one to five layers of graphite planes or graphene sheets with each layer of approximately 0.34 nm (3.4 Å) thick. For graphite oxide flakes, each layer or sheet is approximately 0.64 nm to 1.02 nm in thickness (depending upon the degree of oxidation), but more typically close to 0.74 nm.

The layered material could be graphite, graphite oxide, graphite fluoride, pre-intercalated graphite, pre-intercalated graphite oxide, graphite or carbon fiber, graphite nano-fiber, or a combination thereof. It could comprise a layered inorganic compound selected from a) clay; b) bismuth selenides or tellurides; c) transition metal dichalcogenides; d) sulfides, selenides, or tellurides of niobium, molybdenum, hafnium, tantalum, tungsten or rhenium; e) layered transition metal oxides; f) graphite or graphite derivatives; g) pre-intercalated compounds, or a combination thereof. In the case of graphite flakes, this layered material can react with oxygen in the gaseous environment at an elevated temperature (e.g., higher than 100° C.) to form partially oxidized graphite or graphite oxide.

Certain nano-scaled platelets (e.g., graphite oxides) are hydrophilic in nature and, therefore, can be readily dispersed in selected solvents (e.g., water). Hence, the invented process can include an additional step of dispersing the platelets in a liquid to form a suspension or in a monomer- or polymer-containing solvent to form a nanocomposite precursor suspension. This suspension can be converted to a mat or paper (e.g., by following a paper-making process). The nanocomposite precursor suspension may be converted to a nanocomposite solid by removing the solvent or polymerizing the monomer. Alternatively, the platelets may be mixed with a monomer or polymer to form a mixture, which can be converted to obtain a nanocomposite solid. In the case of graphite oxide platelets, the process may further include a step of partially or totally reducing the graphite oxide (after the formation of the suspension) to become graphite (serving to recover at least partially the high conductivity that a pristine graphite would have).

### BRIEF DESCRIPTION OF THE DRAWINGS

FIG. 1 Schematic of an apparatus that can be used to produce nano-scaled platelets such as nano-scaled graphene plates (NGPs).

FIG. 2 Micrographs showing separate graphene platelets.

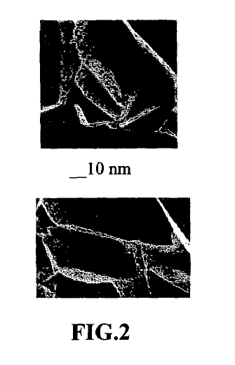

FIG. 3 Selected atomic force micrographs of NGPs.

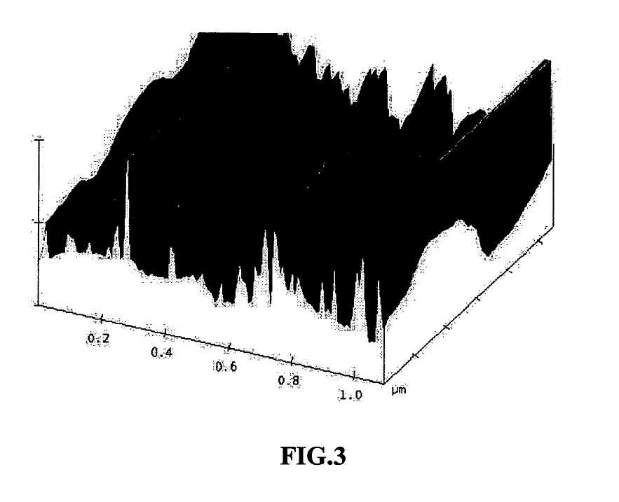

### DETAILED DESCRIPTION OF PREFERRED EMBODIMENTS

One preferred specific embodiment of the present invention is a process for producing a nano-scaled graphene plate (NGP) material that is essentially composed of a sheet of graphene plane or multiple sheets of graphene plane stacked and bonded together. Each graphene plane, also referred to as a graphene sheet or basal plane, comprises a two-dimensional hexagonal structure of carbon atoms. Each plate has a length and a width parallel to the graphite plane and a thickness orthogonal to the graphite plane. The thickness of an NGP is 100 nanometers (nm) or smaller. The length and width of a NGP could exceed 1 μm. Preferably, however, both length and width are smaller than 1 μm. Graphite is but one of the many examples of laminar or layered materials that can be exfoliated to become nano-scaled platelets. A layered inorganic compound may be selected from (a) clay; (b) bismuth selenides or tellurides; (c) transition metal dichalcogenides; (d) sulfides, selenides, or tellurides of niobium, molybdenum, hafnium, tantalum, tungsten or rhenium; (e) layered transition metal oxides; (f) graphite or graphite derivatives; (g) pre-intercalated compounds, or a combination thereof. For instance, both un-intercalated and intercalated graphites are commercially available, which can be exfoliated with the presently invented pressure reduction process, with or without heat. The presently invented process works for all of these classes of laminar materials.

Generally speaking, a process has been developed for exfoliating a layered or laminar material to produce nano-scaled platelets having a thickness smaller than 100 nm. The process comprises: (a) placing a layered material to a gaseous environment at a first temperature and first pressure sufficient to cause gas species to penetrate (into the interstitial space) between layers of the layered material, forming a gas-intercalated layered material; and (b) subjecting the gas-intercalated layered material to a second pressure, or a second pressure and a second temperature, allowing gas species to pressurize or expand the interstitial space, thereby exfoliating the layered material to produce the platelets.

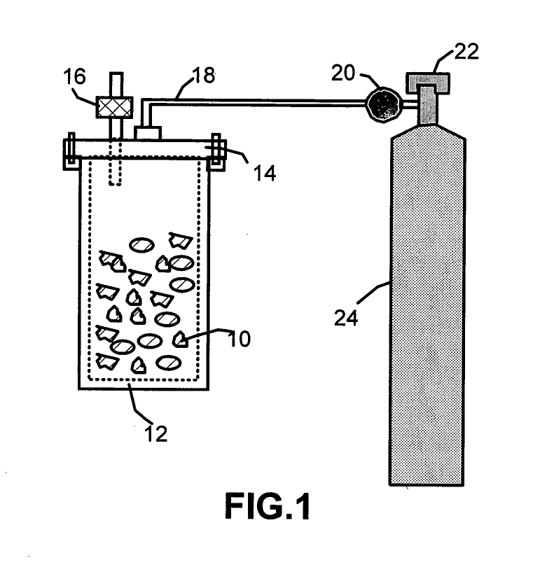

In a preferred embodiment, referring to FIG. 1, the step (a) of subjecting a layered material to a gaseous environment comprises placing the layered material 10 in a sealed vessel 12 containing a pressurized gas (typically at a pressure greater than 1 atm) at a first temperature (typically room temperature or slightly higher). The vessel can be internally or externally heated to provide a controlled first temperature. Step (b) comprises releasing the excess gas from the vessel (suddenly reducing the vessel pressure) and removing the gas-intercalated material from the vessel, preferably into a furnace or oven at a pre-set temperature (typically much higher than room temperature).

The pressurized gas may be supplied from a gas cylinder 24 through a tubing 18, with the gas pressure controlled by a gas regulator 22 and a pressure gauge 20. The gas species can penetrate into the interstitial space between layers of the laminar material and stay therein under a pressure. The amount (solubility) of gas species that can reside in the interstitial space at a given temperature increases with the increasing pressure. After a duration of gas intercalation time (typically from minutes to hours), the excess pressurized gas is released (e.g., through a gas release valve 16) and the gas-intercalated layered material is removed from the vessel (e.g., by removing the cover 14 first). The gas-intercalated material is now at a second pressure (e.g., 1 atm in room air), which is lower than the first pressure (typically greater than 1 atm, typically up to 10 atm, but could be higher). The material is quickly placed in a furnace (with the second temperature being typically in the range of 50° C. to 1,500° C., but more typically between 100° C. to 500° C.), allowing the gas species to exfoliate the layered material by way of pressurizing, expanding, and/or escaping.

It is of great interest to note that prior art exfoliation processes normally involve intercalating laminar materials with liquid or solid intercalants, which are heated to pressurize the interstitial space through vaporization (as a result of chemical decomposition or phase transition). Heating is absolutely required in these prior art processes to achieve exfoliation. In contrast, it is surprising to observe that by simply reducing the surrounding pressure of the laminar material (containing super-saturated gas species residing in the interlayer spaces) in an abrupt or quick manner one could readily exfoliate layered materials. Additional heat is not required. However, optionally and preferably, this pressure reduction step is immediately followed by a step to rapidly expose the gas-intercalated material to a higher temperature that generally produces a high pressure in the interstitial space, leading to a larger expansion ratio (final exfoliated sample thickness/original sample thickness).

Using graphite as an example, the first step may involve preparing a laminar material powder containing fine graphite particulates (granules) or flakes, short segments of carbon fiber (including graphite fiber), carbon or graphite whiskers, graphite nano-fibers, or their mixtures. The length and/or diameter of these graphite particles are preferably less than 0.2 mm (200 μm), further preferably less than 0.01 mm (10 μm), and most preferably smaller than 1 μm. The graphite particles are known to typically contain micron- and/or nanometer-scaled graphite crystallites with each crystallite being composed of one sheet or several sheets of graphite plane. Preferably, large graphite particles are pulverized, chopped, or milled to become small particles or short fiber segments before being sealed in a pressurized chamber. The reduced particle sizes facilitate fast diffusion or migration of an intercalating gas into the interstices between graphite planes in graphite crystallites.

The advantage of having small-sized starting materials may be further illustrated as follows: The diffusion coefficient D of an intercalant between two graphite planes is known to be typically in the range of 10⁻¹² to 5×10⁻⁹ cm²/sec at room temperature [e.g., M. D. Levi and D. Aurbach, J. Phys. Chem. B, 101 (1997) 4641-4647]. The required diffusion time T to achieve a desired diffusion path λ is given approximately by τ=λ²/D. Assume that D=10⁻¹⁰ cm²/sec and λ=100 μm (graphite particle size=100 μm), then the required diffusion time will be τ=(100×10⁻⁴ cm)²/(10⁻¹⁰ cm²/sec)=10⁶ sec (277 hours or 11.5 days). This implies a very lengthy gas intercalation time if the particle size is too large. However, the diffusion time can be reduced if the diffusion temperature T is raised substantially to increase the diffusion coefficient since D=Dₒ exp(−Q/RT), where Q is the activation energy for the diffusion process and R is the universal gas constant. By contrast, if the particle size is λ=1 μm, then τ=(1×10⁻⁴ cm)²/(10⁻¹⁰ cm²/sec)=100 sec at room temperature. This is a very reasonable diffusion time. In the worst case scenario, where D=10⁻¹² cm²/sec (instead of 10⁻¹⁰ cm²/sec), the required intercalation time will be 10,000 sec=2.78 hours for graphite particles with a lateral dimension of 1 μm. This processing time of less than 3 hours can be further reduced by increasing the pressure vessel temperature for interaction.

The second step involves exfoliating the graphite crystallites in the graphite particles by simply releasing the vessel pressure, or by releasing the pressure and quickly placing the gas-intercalated laminar graphite in an oven at a pre-set temperature (typically in the range of 50° C.-1,500° C., but more typically lower than 500° C.). Since the de-intercalation time is also 100 sec or longer, we have sufficient time to transfer the gas-intercalated material from the vessel to the oven. At a much reduced pressure (now 1 atm), the gas solubility in a laminar material (e.g., graphite flakes) is much lower and the excess gas species would want to expand or escape. Surprisingly, even without additional heat, the escaping gas species appear to be capable of overcoming weak van der Waal's forces between layers, thereby delaminating or fully separating graphene planes in a graphite crystallite. This observation could also be theorized as follows: When the laminar material is subjected to a high gas pressure, gas molecules penetrate into the interstitial spaces to the extent that the internal pressure (inside the interstitial spaces) is balanced by the chamber pressure of the sealed vessel. When the chamber pressure is suddenly reduced by releasing the excess gas in the chamber, the gas molecules inside the interstitial spaces find themselves under a high pressure and wanting to expand. This pressure is sufficient to overcome the relatively weak van der Waal's forces between layers, producing separated layers.

Furthermore, when a gas-intercalated material is quickly placed in a pre-heated oven, the interstitial gas pressure is increased dramatically, which is effective to bring about an almost instantaneous and maximum expansion of the laminar particles. Typically, the substantially complete and full expansion of the particles is accomplished within a time of from about a fraction of a second to about 2 minutes, more typically from 1 second to 20 seconds. This can be conducted by pre-heating a furnace to a temperature in the range of 50°-1,500° C., but most preferably in the range of 100° C.-500° C.

Microwave heating was found to be particularly effective and energy-efficient in heating to exfoliate fine graphite particles. Although the presence of some moisture appears to promote exfoliation of minute graphite particles, it is not a necessary requirement when the intercalated sample is microwave-heated. It may take minutes for a microwave oven to heat and exfoliate a treated graphite sample, as opposed to seconds for the cases of pre-heating a furnace to an ultra-high temperature (e.g., 1,500° C.). However, the amount of energy required is much smaller for microwave heating.

An optional third step includes subjecting the exfoliated material to a mechanical attrition treatment to further reduce the particle sizes for producing the desired nano-scaled platelets. With this treatment, either the individual graphene planes (one-layer NGPs) or stacks of graphene planes bonded together (multi-layer NGPs) are reduced to become nanometer-sized in width and/or length. In addition to the thickness dimension being nano-scaled, both the length and width of these NGPs could be reduced to smaller than 100 nm in size if so desired. In the thickness direction (or c-axis direction normal to the graphene plane), there may be a small number of graphene planes that are still bonded together through the van der Waal's forces that commonly hold the basal planes together in a natural graphite. Typically, there are less than 20 layers (often less than 5 layers) of graphene planes, each with length and width smaller than 100 nm, that constitute a multi-layer NGP material produced after mechanical attrition.

Attrition can be achieved by pulverization, grinding, ultrasonication, milling, etc., but the most effective method of attrition is ball-milling. High-energy planetary ball mills were found to be particularly effective in producing nano-scaled graphene plates. Since ball milling is considered to be a mass production process, the presently invented process is capable of producing large quantities of NGP materials cost-effectively. This is in sharp contrast to the production and purification processes of carbon nano-tubes, which are slow and expensive.

The ball milling procedure, when down-sizing the particles, tend to produce free radicals at peripheral edges of graphene planes. These free radicals are inclined to rapidly react with non-carbon elements in the environment. These non-carbon atoms may be selected to produce desirable chemical and electronic properties. Of particular interest is the capability of changing the dispersibility of the resulting nano-scaled platelets in a liquid or matrix material for the purpose of producing nanocomposites. Non-carbon atoms typically include hydrogen, oxygen, nitrogen, sulfur, and combinations thereof.

Another embodiment of the present invention is a process as described above, but the pressurizing gas is produced by placing a controlled amount of a volatile but benign liquid (liquid with a low vaporization temperature such as water, ethanol, and methanol) inside the vessel and implementing a heating element in the vessel to heat and vaporize the liquid. The resulting water and/or alcohol vapor is capable of intercalating interlayer galleries of a range of laminar materials such as graphite oxide and transition metal dichalcogenides. The intercalated compounds may be cooled back to room temperature before the vapor is released, or the vessel may be opened while the intercalant is still in the vaporous state. The water/alcohol-intercalated laminar material is then transferred to a heating zone for a further exfoliation treatment.

Carbon materials can assume an essentially amorphous structure (glassy carbon), a highly organized crystal (graphite), or a whole range of intermediate structures that are characterized in that various proportions and sizes of graphite crystallites and defects are dispersed in an amorphous matrix. Typically, a graphite crystallite is composed of a number of graphene plates (sheets of graphene planes or basal planes) that are bonded together through van der Waals forces in the c-direction, the direction perpendicular to the basal plane. These graphite crystallites are typically micron- or nanometer-sized. The graphite crystallites are dispersed in or connected by crystal defects or an amorphous phase in a graphite particle, which can be a graphite flake, carbon/graphite fiber segment, or carbon/graphite whisker or nano-fiber. In the case of a carbon or graphite fiber segment, the graphene plates may be a part of a characteristic “turbostratic structure.”

When a graphite flake sample is sealed in a vessel containing oxygen at an elevated temperature (200-500° C.), chemical reactions between oxygen and graphite could occur, resulting in the formation of a partially oxidized graphite or graphite oxide. The vessel temperature may be reduced to below 60° C. (so that the sample can be more easily handled) while still under a relatively high pressure. By releasing the pressurizing oxygen gas, one obtains well-exfoliated graphite oxide platelets. This example illustrates the potential of permitting a pressurizing gas to take part in a benign chemical reaction to produce an exfoliated product that is chemically different from the starting laminar material.

In prior art processes, for the purpose of exfoliating graphene plane layers, the chemical treatment of the graphite powder involves subjecting particles of a wide range of sizes to a chemical solution for periods of time ranging from about one minute to about 48 hours. The chemical solution was selected from a variety of oxidizing solutions maintained at temperatures ranging from about room temperature to about 125° C. Commonly used intercalation compounds are H₂SO₄, HNO₃, KMₙO₄, and FₑCl₃, ranging from about 0.1 normal to concentrated strengths. These strong acids are undesirable and, hence, the resulting exfoliated material has to be thoroughly washed, which is an expensive and lengthy process. In contrast, the presently invented process involves the utilization of environmentally benign intercalation gases such as hydrogen, inert gases, or oxygen. No potentially hazardous chemical is required.

Morrison, et al. [U.S. Pat. No. 4,822,590, Apr. 18, 1989] have disclosed a method of preparing single-layer materials of the form MX₂, where MX₂ is a transition metal layer-type dichalcogenide such as MoS₂, TaS₂; WS₂, and the like. The process involved intercalating the MX₂ with an alkali metal (e.g., lithium or sodium) in a dry environment for sufficient time to enable the lithium or sodium to substantially intercalate the MX₂. The lithium- or sodium-intercalated MX₂ is then immersed in water. The water reacts with the intercalated lithium or sodium and forms hydrogen gas between the layers of MX₂. The pressure of the evolved hydrogen gas causes the layers of MX₂ to exfoliate into single layers. This single layer MX₂ material may be useful as a coating and a lubricant. However, pure lithium and sodium must be handled with extreme care in an absolutely dry environment. With a melting point of 180.7° C., lithium will have to be intercalated into MX₂ at a high temperature in a completely water-free environment, which is not very conducive to mass production of exfoliated products. In contrast, the presently invented process does not involve a highly explosive chemical or a violent chemical reaction such as 2 Li+2 H₂O→H₂+2Li⁺+2OH⁻.

Once the nano platelets are produced, the platelets may be dispersed in a liquid to form a suspension or in a monomer- or polymer-containing solvent to form a nanocomposite precursor suspension. The process may include a step of converting the suspension to a mat or paper, or converting the nanocomposite precursor suspension to a nanocomposite solid. If the platelets in a suspension comprise graphite oxide platelets, the process may further include a step of partially or totally reducing the graphite oxide after the formation of the suspension.

Alternatively, the resulting platelets may be mixed with a monomer to form a mixture, which can be polymerized to obtain a nanocomposite solid. The platelets can be mixed with a polymer melt to form a mixture that is subsequently solidified to become a nanocomposite solid.

### EXAMPLE 1

### Nano-Scaled Graphene Platelets (NGPs) from Graphite Flakes

One hundred grams of natural graphite flakes ground to approximately 20 μm or less in sizes were sealed in a hydrogen gas-filled steel container (schematically shown in FIG. 1) at room temperature and 10 atm for four hours to yield the desired gas-intercalated graphite (GIG). Subsequently, the pressure was reduced to 1 atm by releasing the excess gas out of the container. The GIG was found to have been exfoliated to some extent with a small expansion ratio (exfoliated flake thickness/GIG flake thickness) of approximately 2.5/1 to 6/1. A portion of this product was quickly transferred to a furnace at 250° C. to induce extremely rapid and high expansions of graphite crystallites with an expansion ratio of approximately 80 to 150. The thickness of individual platelets ranged from single graphene sheet to approximately 30 graphene sheets. A small portion of the exfoliated graphite particles were then ball-milled in a high-energy plenary ball mill machine for 24 hours to produce nano-scaled particles with reduced length and width (now 0.5-2 μm).

### EXAMPLE 2

### NGPs from Short Carbon Fibers

The procedure was similar to that used in Example 1, but the starting material was carbon fibers chopped into segments with 0.2 mm or smaller in length prior to the gas intercalation treatment. The diameter of carbon fibers was approximately 12 μm. No significant exfoliation was observed immediately after pressure release, but great expansions were achieved after rapid exposure to heat at 600° C.

### EXAMPLE 3

### NGPs from Graphitic Nano-Fibers (GNFs)

A powder sample of graphitic nano-fibers was prepared by introducing an ethylene gas through a quartz tube pre-set at a temperature of approximately 800° C. A small amount of Cu—Ni powder was positioned on a crucible to serve as a catalyst, which promoted the decomposition of the hydrocarbon gas and growth of GNFs. Approximately 2.5 grams of GNFs (diameter of 10 to 80 nm) were intercalated with hydrogen gas at 10 atm. After pressure gas release, the intercalated particles were found to be exfoliated to a great extent (without an expansion ratio measurement). The sample was then rapidly heated to approximately 250° C. to further promote expansion.

### EXAMPLE 4

### Microwave Heating

Same as in Example 3, but heating was accomplished by placing the intercalated sample in a microwave oven using a high-power mode for 3-10 minutes. Very uniform exfoliation was obtained.

### EXAMPLE 5

### Synthesis of Molybdenum Diselenide Nanostructured Materials

The same sequence of steps can be utilized to form nano platelets from other layered compounds: gas intercalation and exfoliation, followed by milling, attrition, or sonication. Dichalcogenides, such as MoS₂, have found applications as electrodes in lithium ion batteries and as hydro-desulfurization catalysts.

For instance, MoSe₂ consisting of Se—Mo—Se layers held together by weak van der Waals forces can be exfoliated via the presently invented process. Intercalation can be achieved by placing MoSe₂ powder in a sealed and pressurized chamber, allowing oxygen to completely intercalate into the van der Waals gap between Se—Mo—Se sheets. After pressure release and heating at 250° C. for less than 5 minutes, the resulting MoSe₂ platelets were found to have a thickness in the range of approximately 1.4 nm to 13.5 nm with most of the platelets being mono-layers or double layers.

Other single-layer platelets of the form MX₂ (transition metal dichalcogenide), including MoS₂, TaS₂, and WS₂, were similarly intercalated and exfoliated. Again, most of the platelets were mono-layers or double layers. This observation clearly demonstrates the versatility of the presently invented process in terms of producing relatively uniform-thickness platelets.

### EXAMPLE 6

### Graphite Oxide Nano Platelets and their Nanocomposites

Graphite oxide was prepared by oxidation of graphite flakes with KMₙO₄/H₂SO₄ followed by a chemical removal step according to the method of Lerf, et al. [J. Phys. Chem., B 102 (1998) 4477-4482]. The interlayer spacing of the resulting laminar graphite oxide was determined by the Debey-Scherrer X-ray technique to be approximately 0.73 nm (7.3 Å), which was found to be conducive to the intercalation by larger gas species such as oxygen and nitrogen molecules.

Selected samples of graphite oxide (particle sizes of approximately 4.2 μm) were sealed in an oxygen-filled chamber at a pressure of approximately 5 atm for two hours at room temperature. The chamber was then isolated from the gas-supplying cylinder with the gas release valve being opened to release the excess gas. The resulting oxygen-intercalated graphite oxide was then transferred to a furnace pre-set at 350° C. to allow for exfoliation. Well separated graphite oxide nano platelets were obtained.

It is of great interest to note that, when mixed with water and subjected to a mild ultrasonic treatment after mixing, these nano platelets were well-dispersed in water, forming a stable water dispersion (suspension). Upon removal of water, the nano platelets settled to form an ultra-thin nano-carbon film. Depending upon the volume fraction of nano platelets, the film could be as thin as one to ten graphite oxide layers (approximately 0.73 nm to 7.3 nm).

A small amount of water-soluble polymer (e.g., poly vinyl alcohol) was added to the nano platelet-water suspension with the polymer dissolved in water. The resulting nano platelet suspension with polymer-water solution as the dispersing medium was also very stable. Upon removal of water, polymer was precipitated out to form a thin coating on nano platelets. The resulting structure is a graphite oxide reinforced polymer nanocomposite.

A small amount of the nano platelet-water suspension was reduced with hydrazine hydrate at 100° C. for 24 hours. As the reduction process progressed, the brown-colored suspension of graphite oxides turned black, which appeared to become essentially graphite nano platelets or NGPs.

An attempt was made to carry out the reduction of graphite oxide nano platelets in the presence of poly(sodium 4-styrene sulfonate) (PSS with Mw=70,000 g/mole). A stable dispersion was obtained, which led to PSS-coated NGPs upon removal of water. This is another way of producing platelet-based nanocomposites.

### EXAMPLE 7

### Clay Nano Platelets and Composites

Bentolite-L, hydrated aluminum silicate (bentonite clay) was obtained from Southern Clay Products. Bentolite clay (5 g) was subjected to room temperature intercalation by argon gas at 5 atm. Exfoliation temperature was 400° C. and the resulting clay nano platelets have a thickness in the range of approximately 1 to 25 nm. The technique used for nanocomposite preparation was melt mixing. The amounts of clay and epoxy were 0.1 g, and 0.9 g, respectively. The mixture was manually stirred for 30 min. When stirring, the sample was actually sheared or “kneaded” with a spatula or a pestle. A well dispersed clay nanoplatelet composite was obtained.

1. A process for exfoliating a layered material to produce nano-scaled platelets having a thickness smaller than 100 nm, said process comprising:
a) subjecting a layered material to a gaseous environment at a first temperature and a first pressure sufficient to cause gas species to penetrate into the interstitial space between layers of the layered material, forming a gas-intercalated layered material; and
b) subjecting said gas-intercalated layered material to a second pressure, or a second pressure and a second temperature, allowing gas species residing in the interstitial space to exfoliate said layered material to produce the platelets.

2. The process of claim 1 wherein said gaseous environment comprises a gas selected from hydrogen, helium, neon, argon, nitrogen, oxygen, fluorine, carbon dioxide, or a combination thereof.

3. The process of claim 1 further including a step of air milling, ball milling, mechanical attrition, and/or sonification to further separate said platelets and/or reduce a size of said platelets.

4. The process of claim 1 wherein said layered material comprises particles with a dimension smaller than 1 μm.

5. The process of claim 1 wherein said layered material comprises particles with a dimension smaller than 1 μm.

6. The process of claim 1 wherein said platelets have a thickness smaller than 10 nm.

7. The process of claim 1 wherein said platelets have a thickness smaller than 1 nm.

8. The process of claim 1 wherein said platelets comprise single graphene sheets having a thickness of approximately 0.34 mm.

9. The process of claim 1 wherein said second pressure is lower than said first pressure.

10. The process of claim 1 wherein said second pressure is lower than said first pressure and said second temperature is higher than said first temperature.

11. The process of claim 1 wherein said layered material comprises graphite, graphite oxide, graphite fluoride, pre-intercalated graphite, pre-intercalated graphite oxide, graphite or carbon fiber, graphite nano-fiber, or a combination thereof.

12. The process of claim 1 wherein said layered material comprises a layered inorganic compound selected from a) clay; b) bismuth selenides or tellurides; c) transition metal dichalcogenides; d) sulfides, selenides, or tellurides of niobium, molybdenum, hafnium, tantalum, tungsten or rhenium; e) layered transition metal oxides; f) graphite or graphite derivatives; g) pre-intercalated compounds, or a combination thereof.

13. The process of claim 1 wherein said step (a) of subjecting a layered material to a gaseous environment comprises placing said material in a sealed vessel containing a pressurized gas and said step (b) comprises opening said vessel to partially or totally release the gas.

14. The process of claim 13 further comprising a step, after gas release, of placing said gas-intercalated material in a heated zone or of subjecting said gas-intercalated material to microwave or dielectric heating.

15. The process of claim 1 wherein said layered material reacts with a gas in said gaseous environment.

16. The process of claim 1 further including a step of dispersing said platelets in a liquid to form a suspension or in a monomer- or polymer-containing solvent to form a nanocomposite precursor suspension.

17. The process of claim 15 further including a step of dispersing said platelets in a liquid to form a suspension or in a monomer- or polymer-containing solvent to form a nanocomposite precursor suspension.

18. The process of claim 16 further including a step of converting said suspension to a mat or paper, or converting said nanocomposite precursor suspension to a nanocomposite solid.

19. The process of claim 17 further including a step of converting said suspension to a mat or paper, or converting said nanocomposite precursor suspension to a nanocomposite solid.

20. The process of claim 1 further including steps of mixing said platelets with a monomer or polymer to form a mixture and converting said mixture to obtain a nanocomposite solid.

21. The process of claim 15 further including steps of mixing said platelets with a monomer or polymer to form a mixture and converting said mixture to obtain a nanocomposite solid.

22. The process of claim 16 wherein said platelets comprise graphite oxide platelets and said process further includes a step of partially or totally reducing said graphite oxide after the formation of said suspension.

23. The process of claim 17 wherein said platelets comprise graphite oxide platelets and said process further includes a step of partially or totally reducing said graphite oxide after the formation of said suspension.

24. The process of claim 1 wherein said layered material is placed in a sealed vessel and said gas environment is produced by vaporizing a liquid inside said vessel.
